(19) United States
(12) Patent Application Publication
(10) Pub. No.: US 2018/0166898 A1
(43) Pub. Date: Jun. 14, 2018

(54) Flameless Candle Recharging Station

(71) Applicant: LeoLight Inc., Concord (CA)

(72) Inventors: Daniel Schreiber, Toronto (CA); Christopher Rasmussem, Toronto (CA)

(21) Appl. No.: 15/836,820

(22) Filed: Dec. 8, 2017

Related U.S. Application Data
(60) Provisional application No. 62/431,619, filed on Dec. 8, 2016.

(51) Int. Cl. H02J 7/00

(52) U.S. Cl. CPC H02J 7/0044; F21S 9/02; H02J 7/0021

(57) ABSTRACT

A flameless candle recharging station is provided with one or more recharge trays. Each tray is provided to house multiple rechargeable, flameless candles. In an embodiment, the station base is rotatable, and each tray is detachable from the station base. In a further embodiment, the recharge trays mount vertically onto the station base and hold the flameless candles at a 45-degree angle.

### CLAIM OF PRIORITY

This application claims priority to U.S. Provisional Patent Application Ser. No. 62/431,619, entitled “Flameless Candle Recharging Station” and filed on Dec. 8, 2016, the entire contents of which are hereby incorporated by reference herein.

### FIELD OF THE INVENTION

The present invention relates to the field of recharging a large plurality of electronic flameless candles used to simulate actual flame candles. More specifically, the invention relates to a flameless candle recharging station.

### BACKGROUND

Illuminating poorly lit areas has been a key requirement throughout human evolution and development, starting from the discovery of a flame. The flame has not only provided illumination, but has been found to have a very soothing and calming effect on users. Users have historically and continue today to turn to a flame for illuminating poorly lit areas even after more practical ways of lighting have been invented. Users find the wavelength of light emitted and flickering movement of the flame very soothing and calming. Wax candles are still used today even though more practical electrical lighting systems are readily available. Users will turn off electrically powered lights in the dwelling or business and light a wax candle to immerse themselves with the soothing effect of an open flame. The problem with the use a wax candle is the inherent danger of an open flame within a dwelling or business. Leaving a lit wax candle unattended can pose serious risk to the user and to the space. As such, flameless electric candles have been devices to alleviate inherent dangers with an open flame associated with wax candles while providing the soothing aspects of the wavelength of light emitted and flickering movement of the flame. An electric candle invention was described as early as 1962, in U.S. Pat. No. 3,194,955.

Electronic candles require an electric current to produce a flame like illumination, which is usually provided in the form of a battery. Batteries require replacement or recharging. Recharging batteries is the preferred method by users, as it is cost effective and environmentally friendly. The use of multiple flameless electric candle can make recharging quite onerous and time consuming, as each individual flameless electric candle is required to be plugged into a electric source in order to have the batteries within the flameless candle recharged.

Various attempts have been made to alleviate the inconvenience associated with manually plugging each individual flameless electric candle into an electric source by disclosing a charging tray station. Devices such as U.S. Pat. No. 8,454,190 (Hau); U.S. Pat. No. 8,579,461 (Fournier); and U.S. Pat. No. 8,845,166 (Lederer) provide such examples of charging tray stations.

All three patents described below have a number of inherent deficiencies. Firstly, all the trays are interconnected, and as such, the recharging current is required to travel through a tray before it is passed onto the next tray down the interconnection line. As a result, and as more trays are interconnected, the current is gradually dissipated, and the recharging efficiency is lost. The result is that as more trays are interconnected through a single line; the more time is required to fully charge all the candles within the system. Secondly, the footprint of the trays, when interconnected, is quite cumbersome and take up a lot of space, which in a business setting is at a premium. Thirdly, the ease of access to the flameless candles within the tray is sometimes difficult, often requiring the user to reach under of to stretch.

Hau discloses an induction rechargeable electronic candle system with a motion detector. The system described in Hau employs a series of interconnected charging trays that simultaneously recharge a plurality of artificial, battery-operated, electronic candles. A transformer produces a battery charging current that is controlled by a microprocessor. The system described in Hau can simultaneously recharge a large number of flameless electronic candles, but has a number of inherent deficiencies as described above. Additionally, the Hau system requires the user to work inefficiently as they are required to physically move and stretch in order to place all of the flameless electric candles into the individual charging ports.

Fournier discloses a rechargeable flameless candle system and methods. Fournier discloses a stackable tray system that includes a plurality of recharging ports that receives and recharges the battery within a flameless electric candle. The stackable trays contain a charging indicator that provides a user with the charge status of the individual flameless electric candles set within the recharging ports. The stackable trays are stacked one on top of the other and pass the electric recharging current through an interconnection. As was the limitation with Hau, the Fournier system loses the electric current as more stackable trays are interconnected. As a result, it takes longer for the individual flameless electric candles to be recharged the more stackable trays are interconnected. Placement and removal of individual flameless electric candles from the stackable tray system is quite challenging. Ports of stackable trays on the bottom of the stack are in essence, buried by the upper stackable trays and, as such, are very hard to get at for a user requiring to remove or place a flameless electric candle.

Lederer discloses a washable, rechargeable electronic candle. Within the invention, Lederer discloses a multi-charge station with six ports, each of which charges a flameless electric candle. Lederer did not conceive a multi-charge tray requiring to charge up to forty-eight individual flameless electric candles, and as such, falls short on its applicability in such situations.

As such, there is a need for a flameless candle recharge station that can overcome the drawbacks as described above. Indeed, there is a need for a flameless candle recharge station that can charge up a large number of flameless electric candles without losing power and efficiency of charge when charging the maximum number of candles. Preferably, the recharge trays within the station should not lose electric current as more recharging trays are added in an attempt to accommodate increased amount of flameless electric candles. Finally, there is a need for a flameless candle recharge station that is user friendly, in that is easy for a user to quickly assess all the recharge ports within the individual recharge trays, while minimizing the station's footprint.

### SUMMARY

The present invention, in various embodiments, provides a flameless candle recharge station for recharging the batteries of an plurality of flameless candles. The flameless candle recharge station is primarily comprised of a set of recharge tray packs, and a rotating station base. Each recharge tray is to charge an electric candle, standing upright to minimize space. A recharge tray pack may include two or more recharge trays plus the rotating base. Each recharge tray of the recharge tray pack is secured vertically onto the station base and obtains an electric current directly from the station base. The current obtained by the recharge tray is subsequently used to recharge a plurality of housed flameless candles.

### BRIEF DESCRIPTION OF THE DRAWINGS

It will now be convenient to describe the invention with particular reference to an embodiment of the present invention. It will be appreciated that the drawings relate to an embodiment of the present invention only and are not to be taken as limiting the invention.

FIG. 1 is a perspective view of a flameless candle recharge station, according to one embodiment of the present invention;

FIG. 2 is a perspective view of a recharge tray, according to one embodiment of the present invention;

FIG. 3a is a front view of the recharge tray, according to one embodiment of the present invention;

FIG. 3b is a bottom view of the recharge tray, according to one embodiment of the present invention;

FIG. 4a is a top view of the recharge tray, according to another embodiment of the present invention;

FIG. 4b is a top view of the recharge tray, with the latch of the male connector extended, according to another embodiment of the present invention;

FIG. 4c is a top view of a recharge tray pack, according to another embodiment of the present invention;

FIG. 5a is a top view of a plurality of recharge trays not latched together, according to another embodiment of the present invention;

FIG. 5b is a top view of the recharge tray pack latched together, according to another embodiment of the present invention;

FIG. 6a is a bottom view of the recharge tray, according to another embodiment of the present invention;

FIG. 6b is a bottom view of the recharge tray pack, according to another embodiment of the present invention;

FIG. 7a is a side view of a display base, according to one embodiment of the present invention;

FIG. 7b is a top view of the display base, according to another embodiment of the present invention;

FIG. 8a is a side view of the flameless candle recharge station, according to one embodiment of the present invention; and,

FIG. 8b is a top view of the flameless candle recharge station, according to one embodiment of the present invention.

### DETAILED DESCRIPTION

The present invention will now be described more fully hereinafter with reference to the accompanying drawings, in which preferred and other embodiments of the invention are shown. No embodiment described below limits any claimed invention and any claimed invention may cover processes or apparatuses that are not described below. The claimed inventions are not limited to apparatuses or processes having all the features of any one apparatus or process described below or to features common to multiple or all of the apparatuses described below. It is possible that an apparatus or process described below is not an embodiment of any claimed invention. The applicants, inventors or owners reserve all rights that they may have in any invention claimed in this document, for example the right to claim such an invention in a continuing application and do not intend to abandon, disclaim or dedicate to the public any such invention by its disclosure in this document.

The terms “coupled” and “connected”, along with their derivatives, may be used herein. It should be understood that these terms are not intended as synonyms for each other. Rather, in particular embodiments, “connected” may be used to indicate that two or more elements are in direct physical or electrical contact with each other. “Coupled” may be used to indicated that two or more elements are in either direct or indirect (with other intervening elements between them) physical or electrical contact with each other, or that the two or more elements co-operate or interact with each other (e.g. as in a cause and effect relationship).

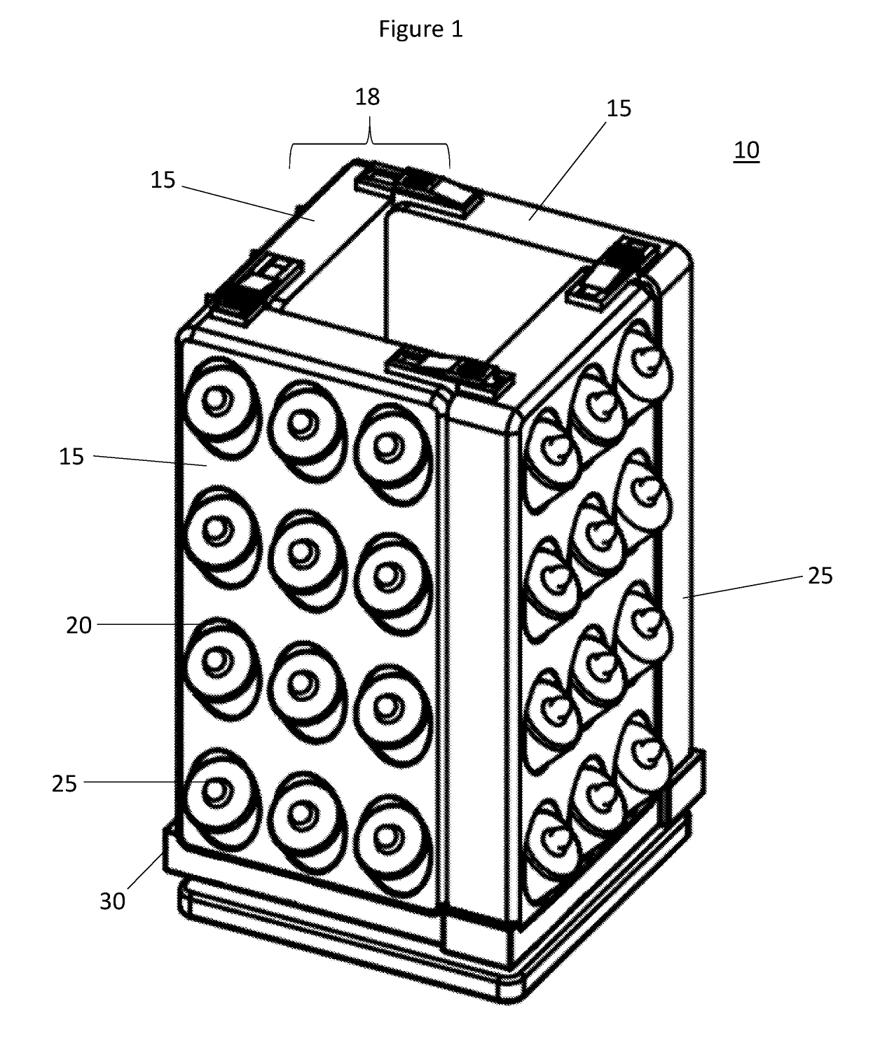

With reference to FIG. 1 and according to one embodiment of the present invention, a flameless candle recharge station is shown. The flameless candle recharge station 10 is primarily composed of: one or more recharge trays 15; and, a station base 30. Two or more recharge trays 15, when grouped together are considered as a recharge tray pack 18. The flameless candle recharge station 10 is designed for efficient recharging batteries of multiple flameless candles 25 (or recharging flameless candles). Multiple industries employ a multitude of candles to create an ambiance within a space. For example, restaurants and spas frequently use a large number of candles in their spaces to reduce the unpleasant lighting of ceiling lights while creating a warm and inviting ambiance. Electric candles have become commonplace in these industries as they are much safer and a lot easier to maintain. The flameless candle recharge station 10 allows a user to efficiently recharge a large number of flameless candles without the fear of loosing electric current as more flameless candles 25 and recharge trays 15 are added to the station base 30. The footprint of the flameless candle recharge station 10 is small, thereby decreasing the amount of space needed to recharge a large number of flameless candles 25. It is well known in the industries that employ flameless candles that it is often difficult to find space to recharge the flameless candles 25. More often then not, flameless candles are recharged in the back rooms, or in kitchens, where space is at a premium. The vertical placement of the recharge trays 15 allow for the flameless candles 25 to be stacked vertically, thereby saving space and permitting ease of access to all flameless candles 25. The flameless candles 25 are recharged in the recharge tray 15 through the candle cavity 20. The candle cavity 20 is set at a 45° angle with respect to the vertical recharge tray 15. The flameless candle 25 is set within the candle cavity 20 and as such extrudes out from the recharge tray 15 at a 45° angle. The recharge trays 15 are mounted vertically within the station base 30 in a side-to-back manner forming a hollow square. The station base 30, can rotate around the vertical axis, thereby providing a user quick and efficient means to access all the flameless candles 25 without the need for the user to reach around or physically move.

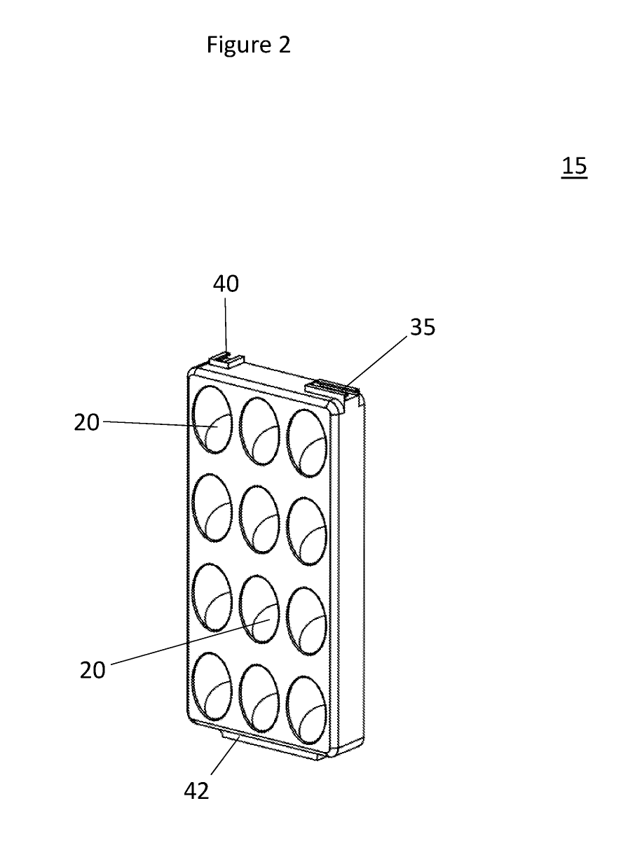

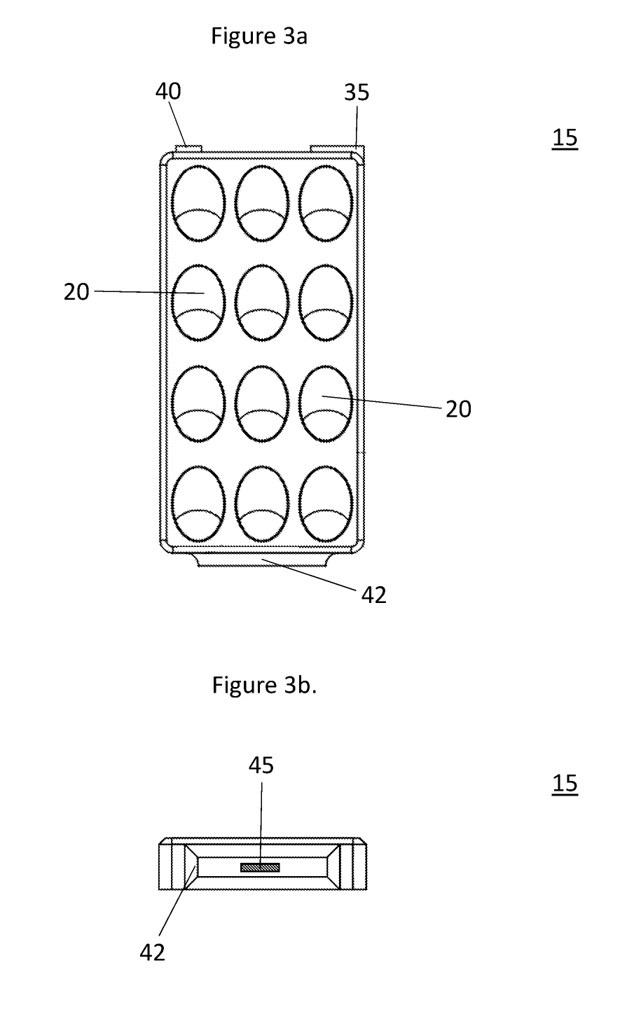

With reference to FIGS. 2 and 3, and according to one embodiment of the present invention the recharge tray 15 is shown in greater detail. The recharge tray is a vertical tray that houses and recharges a number of flameless candles (not shown). The recharge tray is shown to having twelve candle cavities 20, each capable of charging one flameless candle (not shown). For ease of understanding and clarity, the recharge tray 15 is consistently depicted with twelve candle cavities 20. A worker skilled in the relevant art would appreciate that the number of candle cavities 20 is only dependent on the size of the recharge tray 15. The candle cavity 20 is set within the recharge tray at a 45° angle. The 45° angle is potentially optimal as it provides the optimal compromise between ease of access to the flameless candle 25 and the use of gravitational force to keep the flameless candle 25 in place. The recharge tray 15 is mounted onto the station base (not shown) in a vertical orientation. The recharge tray 15 is mounted on the station base (not shown) through the mounting shoulder 42. A worker skilled in the relevant art would appreciate the various means of mounting the recharge tray 15 to the station base (not shown) including, but not limited to: posts; hooks; clamps; suction means; latches; pins and other potential options for mounting. The male and female connection body, 35 and 40, respectively, act as a connection means, and are positioned on the top of the recharge tray 15. The male and female connection body, 35 and 40, respectively, aid in vertical positioning of the recharge tray 15 when multiple recharge trays 15 are used at one time on the station base (not shown). With specific reference to FIG. 3a, the front view of the recharge tray 15 is shown. The mounting means consisting of the tray mounting shoulder 42 and the male and female connection bodies, 35 and 40, respectively, are shown at the bottom and at the top of the recharge tray 15. The candle cavities 20 are located on the front face of the recharge tray 15. With specific reference to FIG. 3b, the bottom view of the recharge tray 15 is shown. As shown, the tray mounting shoulder 42 projects from the base of the recharge tray 15 thereby allowing the mounting shoulder 42 to penetrate a chamber in the station base (not shown). A power supply port 45 is set within the mounting shoulder 42. The power supply port 45 electrically connects the recharge tray 15 with the electrical output of the station base (not shown). The power supply port 45 provides a recharge current to all the candle cavities 20 as it acts as a conduit for electricity from the station base (not shown) to all the candle cavities 20. A worker skilled in the relevant art would appreciate the connecting means required to electrically connect the individual candle cavities 20 with the power supply port 45 wherein each candle cavity 20 would be supplied with sufficient and constant current required to recharge a flameless candle (not shown) set within the candle cavity 20. A worker skilled in the relevant art would also appreciate the various electrical mating means that could be employed to electrically connect the recharge tray 15 to the station base (not shown). The method of transferring current from the recharge tray 15 to the individual flameless candles 25 is known in the art and a worker skilled in the relevant would appreciate the various methods and types of components capable of achieving a necessary electrical connection that can be employed.

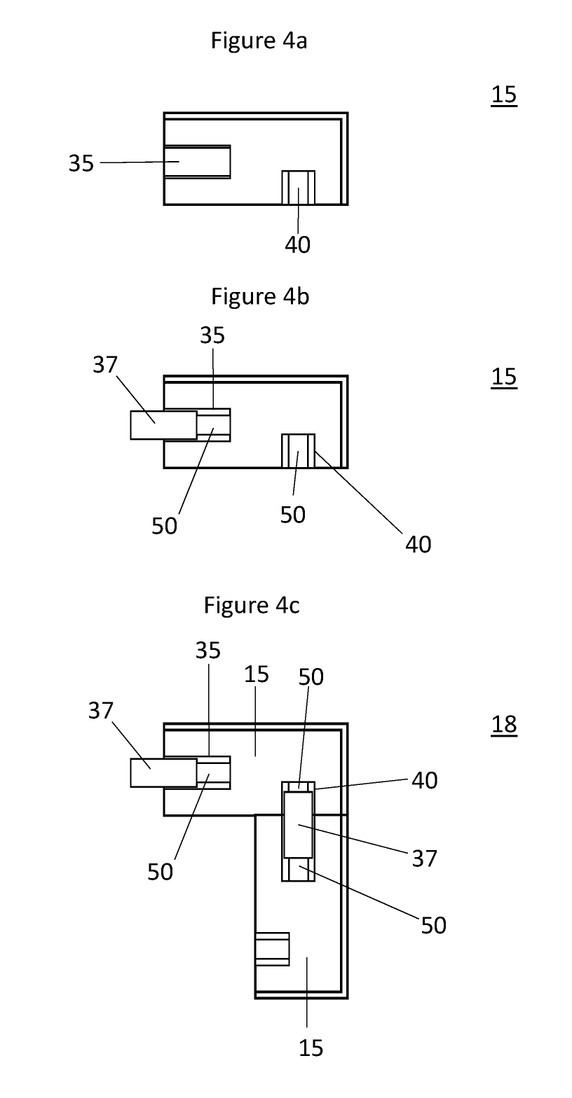

With reference to FIG. 4 and according to another embodiment of the present invention, the top of the recharge tray 15 is shown in greater detail. The top of the recharge tray 15 is shown in an alternative embodiment and constitutes one of many possible variations in shape and style of the recharge tray 15. The top of the recharge tray 15 is comprised of a flat surface with a male and female connection body, 35 and 40, respectively. With specific reference to FIG. 4b, the top of the recharge tray 15 is shown with the male boom extension 37 pushed out. The male boom extension slide on the boom track 50, located at the bottom of the male connection body 35. The bottom of the female connection body 40 also contains the boom track 50. As such, the extension boom 37 can connect to, and run across the boom track 50 of the female connection body 40. With specific reference to FIG. 4c the top of a recharge tray pack 18 is shown. The illustrated recharge tray pack 18 is comprised of two recharge trays 15. A recharge tray pack 18 can consist of a number of recharge trays 15, from as little as two to as many as eight. For consistency of the patent application, the number of recharge trays 15 in a recharge tray pack 18 is shown in an orientation for a maximum of four, which when put together forms a hollow square. When forming the recharge tray pack 18, the side of recharge tray 15 is placed on the back of an adjacent recharge tray 15. The resultant positioning aligns the male connection body of one recharge tray 15 with the female connection body 40 of the adjacent recharge tray 15. The male boom extension 37 can extend across into the adjacent recharge tray 15 and run along the boom track of the female connection body 40. Once the male boom extension 37 of the male connection body 35 has travelled onto the female connection body 40, the two adjacent recharge trays 15 are locked into position, thereby forming the recharge tray pack 18. A worker skilled in the relevant art would appreciate the various locking means that can be employed to lock adjacent recharge trays together, including but not limited to: bolt; clamp; latch; and hook. In the recharge tray pack 18 orientation, the tray mounting shoulder (not shown) are aligned to mount onto the station base (not shown).

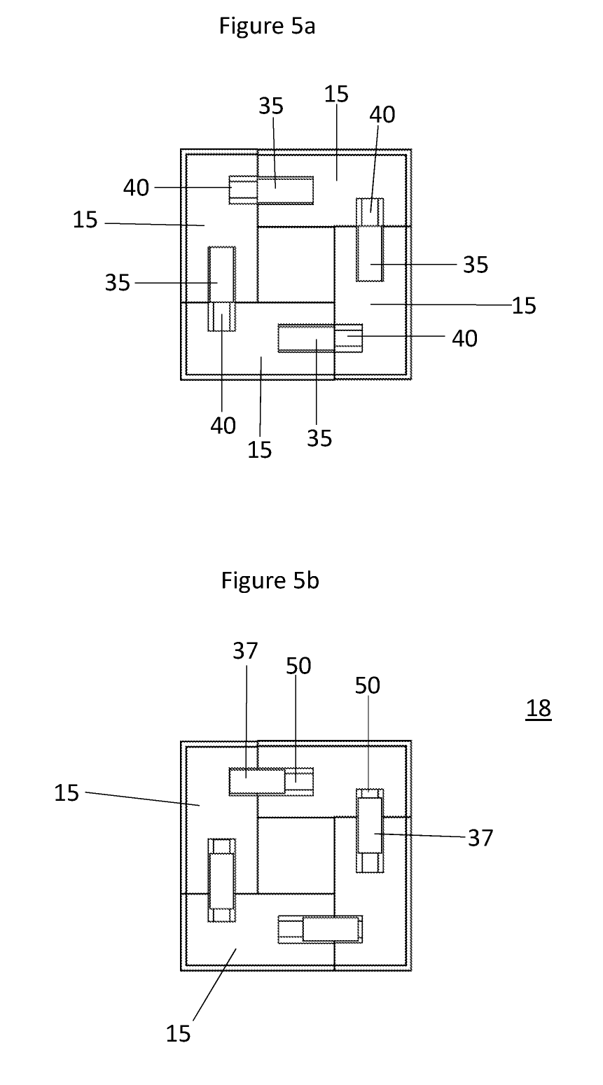

With reference to FIGS. 5a and 5b, the locking mechanism of the recharge trays 15 in forming the recharge tray pack 18 is shown in greater detail. The outer shape of the recharge tray 15 along with the location of the male and female connection bodies, 35 and 40, respectively, along the top of the recharge tray 15 are essential in determining the maximum size of the recharge tray pack 18. A worker skilled in the relevant art would appreciate the various outer shape of the recharge tray 15 and location of the male and female connection bodies, 35 and 40, respectively, will vary in relation to the maximum amount of recharge trays needed to form the recharge tray pack. As the current is passed from the station base (not shown) to the individual recharge trays 15, the amount of recharge trays 15 that can be set to form the recharge tray pack is limited only by the space in which the flameless candle recharge station is placed in. With specific reference to FIG. 5a, and based on the design used for illustrative purpose, four recharge trays are positioned in a manner that will form the recharge tray pack 18. Each of the four recharge trays 15 is aligned in a manner that the male connection body 35 of one recharge tray is aligned with the female connection body 40 of an adjacent recharge tray 15. As a result, the four recharge trays 15 form the shape of a hollow square. The aligned recharge trays 15 have not yet formed the recharge tray pack 18, as the individual recharge trays 15 have not been locked into position through the extension of the male boom extension 37. With specific reference to FIG. 5b the top of the recharge tray pack 18 is shown. The recharge trays 15 now form the recharge tray pack 18 as the individual recharge trays 15 are locked into one another through the sliding of the male boom extension 37 of the male connection body 35 onto the female connection body 40. The male boom extension 37 is shown at different time points of the locking mechanism. Depending on the time point, the boom extension 37 has travelled a varying amount across the boom track 50 of the female connection body 40.

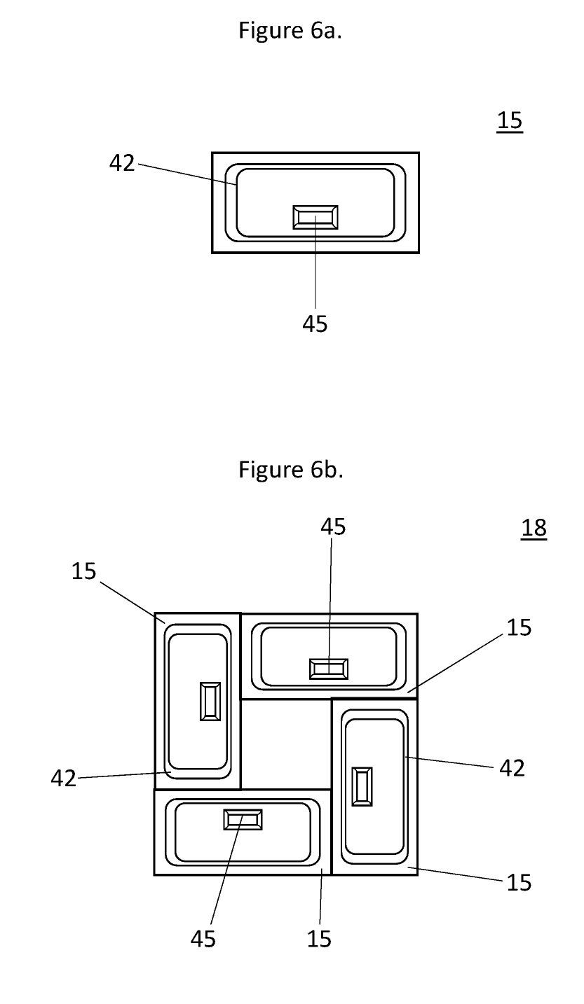

With reference to FIGS. 6a and 6b and according to another embodiment of the present invention, the bottom of the recharge tray 15 is shown in greater detail. The bottom of the recharge tray 15 is shown in an alternative embodiment and constitutes one of many possible variations in shape and style of the recharge tray 15. The bottom of the tray is comprised of the tray mounting shoulder 42 and the power supply port 45. The power supply port 45 is positioned on the mounting shoulder 42 in a manner where it will align with the power supply dock of the station base (not shown). The mounting shoulder 42 mounts within the mounting cavity of the station base (not shown). With specific reference to FIG. 6b the bottom of the recharge tray pack 18 is shown. The recharge tray pack 18 is comprised of four recharge trays 15. The overall shape corresponds to the shape that is provided within in the station base (not shown) to ensure optimal fitment. Each individual recharge tray 15 of the recharge tray pack 18 is electrically connected to the station base (not shown). The power supply ports 45 of each individual recharge trays 15 are located on the base and are connected to the power supply dock of the station base (not shown). No current is passed between the recharge trays 15, and as such, the current passing through all of the recharge trays 15 within the recharge tray pack 18 are consistent. There is no observable decrease in electrical current as more recharge trays 15 are added into the recharge tray pack 18, and as such, all of the flameless candles placed within the recharge trays 15 are recharged at an equal rate.

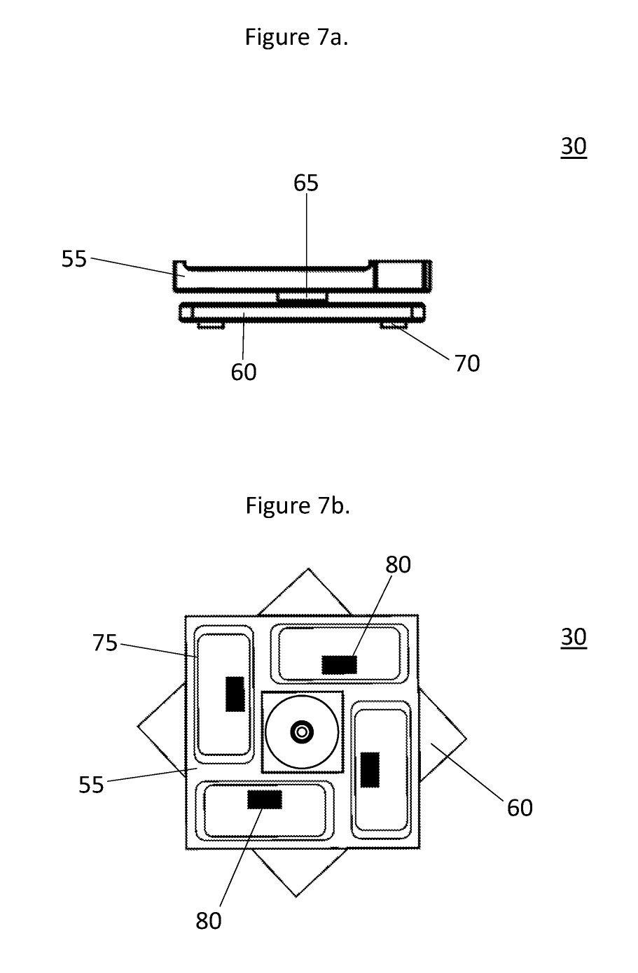

With reference to FIGS. 7a and 7b and according to one embodiment of the present invention, the station base 30 is shown. The station base 30 is comprised of: a turntable platform 55; station stand 60; shaft assembly 65; and, base pads 70. The station base is connected to a power source, such as a power outlet and subsequently provides electric current to mounted recharging trays (not shown). A transformer located in or around the station base 30 transforms the electric current flowing from the power outlet (not shown) to four power supply docks 80. A power outlet is defined as the electric source within a living space, usually originating from a plug within a wall. The shaft assembly 65, which connects the turntable platform 55 to the station stand 60 allows the turntable platform 55 to rotate freely around the vertical axis. As such, the turntable platform 55 rotates freely around the vertical axis while the station stand 60 is remains fixed and stationary. The rotation of the turntable platform 55 is achieved through a series of bearings located within the shaft assembly 65. A worker skilled in the relevant art would appreciate the various means of achieving rotation of the turntable platform 55 around the stationary station stand 60. The base pads 70 help protect the surface on which the station base 30 is place upon. Additionally, the base pads 70 correct minor irregularities of the surface upon which the station base 30 is placed upon to help keep the station base 30 level. A worker skilled in the relevant art would appreciate the various methods of protecting the and correcting minor irregularities on the surface upon which the station base 30 is placed upon. With specific reference to FIG. 7b, a top view of the station base 30 is shown. The station base 30 is shown with the turntable platform 55 rotated along the vertical axis in a manner where it is no longer aligned with the station stand 60. The top of the turntable platform 55 contains numerous mounting cavities 75, which correspond to the tray mounting shoulders of individual recharge trays when locked together to form the recharge tray pack (not shown). As such, the mounting cavities 75 provide stability and security when recharge trays (not shown) are mounted. The power supply dock 80 electrically connects the station base 30 to mounted recharge trays (not shown). A worker skilled in the relevant art would appreciate the interaction between the turntable platform 55 of the station base 30 and the individual recharge trays (not shown), and as such, would appreciate the positioning of the power supply dock 80 in correlation with the power supply port of the individual recharge trays (not shown).

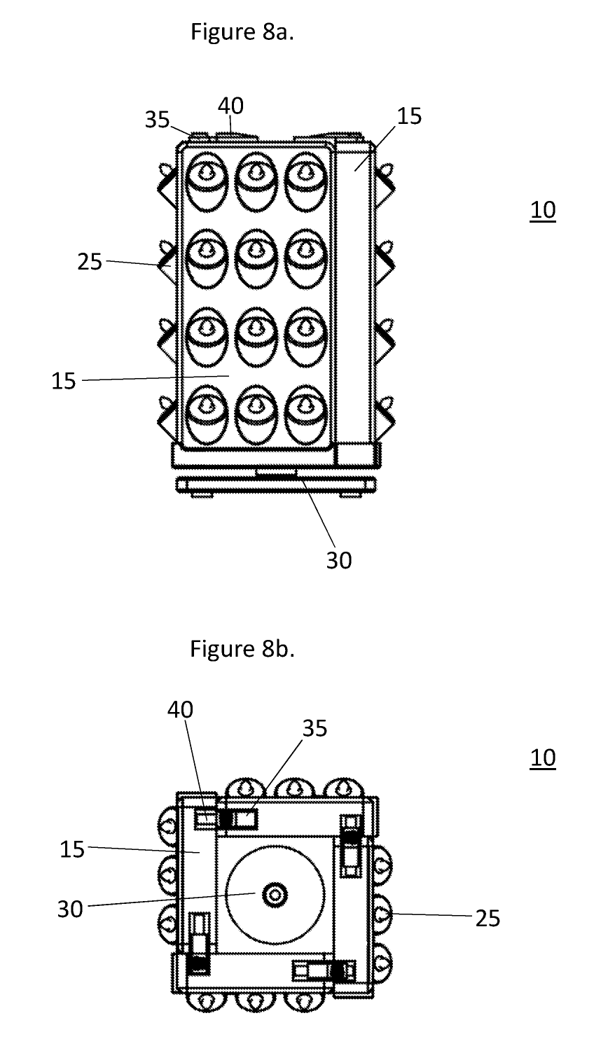

With reference to FIGS. 8a and 8b and according to one embodiment of the present invention the flameless candle recharge station 10 is shown housing and recharging a plurality of flameless candles 25. The flameless candles 25, when mounted into the candle cavity 20 of the recharge tray 15 protrudes out from the surface of the recharge tray 15 at a 45° angle. The protrusion at the 45° angle allows easy retrieval and subsequent placement back into the candle cavity 20. Each candle cavity 20 on the recharge tray 15 is easily accessible to the user. The rotation of the base around the vertical axis provides the user with easy access to the flameless candles 25 set in recharge trays 15. The user can easily access the flameless candles 25 that are not directly facing the user. Placement of the flameless candle 25 into the candle cavity 20 at a 45° degree angle provides not only ease of placement, but allows the flameless candle 25 to use the force of gravity to enter completely into the candle cavity 20 and make contact with the charging electrodes (not shown). The contact between the flameless candle 25, and more specifically the flameless candle power charge port (not shown), and the charging electrodes (not shown) within the candle cavity 20 is essential for recharging the flameless candle in embodiments using electrodes based on direct contact. The flameless candles 25 charge by connecting to a charging electrode (not shown) contained within the candle cavity. A worker skilled in the relevant art would appreciate the various mechanisms of connecting a flameless candle to an electrical source. A worker skilled in the relevant art would understand that the electrodes used to charge the flameless candle 25 can be positioned anywhere within the candle cavity 20 as long as it coincides with the location of the electrical port located on the flameless candle 25. To indicate charging or fully charged, the flameless candles are equipped with a charge sensor and two light emitting diodes (LED) lights, green and red. The green LED light corresponds to an indication that the flameless candle is fully charged, while the red LED light corresponds to an indication that the flameless candle is charging. The charge sensor within the flameless candle 25 will light up either the green or red LED depending on the charge. The sensor lights up either green or red LED only when it is plugged into a charging source within the candle cavity 20. The amount of surface area that the flameless candle recharge station 10 occupies is significantly less that would be required if the recharge trays 15 are placed horizontally. With specific reference to FIG. 8b, the top view of the flameless candle recharge station 10 is shown. The recharge tray pack 18, comprised of multiple interconnected recharge trays 15, forms a square hollow shape when placed on top of the station base 30. The interconnection of the recharge trays 15 is achieved through the interaction with the station base 30 and through the male and female connection body, 35 and 40, respectively, locking mechanism.

While the invention has been described with reference to certain embodiments, it will be understood by those skilled in the relevant art that various modification may be made and equivalents substituted without departing from the scope and the spirit of the invention. It is intended that the invention not be limited to the particular embodiment disclosed, but that the invention will include all embodiments falling within the scope of the claims provided.

What is claimed is:

1. A flameless candle recharge station comprising:
a. a station base; and
b. one or more recharge trays removably mounted to the station base; each recharge tray having a plurality of charging cavities to receive one or more flameless candles,
wherein the station base obtains an electrical current from a power supply, and wherein the station base transmits the electrical current to recharge the one or more flameless candles residing in the plurality of charging cavities of the one or more recharge trays.

2. The flameless candle recharge station of claim 1, wherein the one or more recharge trays are removably mounted to the station base with a vertical orientation.

3. The flameless candle recharge station of claim 2, wherein the plurality of charging cavities is positioned to hold the one or more flameless candles at a 45° angle.

4. The flameless candle recharge station of claim 3, wherein the station base is rotatable.

5. The flameless candle recharge station of claim 1, wherein the one or more recharge trays further provided with a means to attach to one another to form a recharge tray pack.

6. The flameless candle recharge station of claim 5, wherein the recharge tray pack is removably mounted to the station base with a vertical orientation.

7. The flameless candle recharge station of claim 6, wherein the plurality of charging cavities is positioned to hold the one or more flameless candles at a 45° angle.

8. The flameless candle recharge station of claim 7, wherein the station base is rotatable.

9. A flameless candle recharge station comprising:
a. a rotatable station base;
b. a recharge pack including a plurality of recharge trays removably mounted to the station base with a vertical orientation; each recharge tray having a plurality of charging cavities to receive one or more flameless candles at a 45° angle,
wherein the station base receives an electrical current from a power supply, and wherein the station base transmits the electrical current to recharge the one or more flameless candles residing in the plurality of charging cavities of the one or more recharge trays
wherein the one or more recharge trays are removably mounted to the station base with a vertical orientation;
and
wherein each recharge tray of the plurality of recharge trays further provided with a means to attach to another recharge tray of the plurality of recharge trays to form the recharge tray pack.
